(19) United States
(12) Patent Application Publication
(10) Pub. No.: US 2020/0079939 A1
(43) Pub. Date: Mar. 12, 2020

(54) LOW IMPACT CO2 EMISSION POLYMER COMPOSITIONS AND METHODS OF PREPARING SAME

(71) Applicant: Braskem S.A., Camaçari (BR)

(72) Inventors: Gabriel Degues Müller, São Paulo (BR); Ricardo de Oliveira Dias, São Paulo (BR); Ederson Munhoz Reis Matos, São Paulo (BR)

(73) Assignee: Braskem S.A., Camaçari (BR)

(21) Appl. No.: 16/564,415

(22) Filed: Sep. 9, 2019

Related U.S. Application Data
(60) Provisional application No. 62/728,680, filed on Sep. 7, 2018.

(51) Int. Cl. C08L 23/06; C08L 23/12; C08L 23/08

(52) U.S. Cl. CPC C08L 23/06; C08L 23/12; C08L 23/0853; C08L 2205/025; C08L 2207/066; C08L 2207/20; C08L 2207/062

(57) ABSTRACT

Blended polymer compositions and methods of making same may include a first component including one or more biobased polymer compositions; a second component including one or more recycled polymer compositions; and an optional third component including one or more virgin petrochemical resins, wherein the wt % of each component is selected such that the polymer composition exhibits an Emission Factor Blend of less than or equal to 1.0 kg CO₂/kg of the blended polymer composition.

### BACKGROUND

Polyolefins such as polyethylene (PE) and polypropylene (PP) may be used to manufacture a varied range of articles, including films, molded products, foams, and the like. Polyolefins may have characteristics such as high processability, low production cost, flexibility, low density and recycling possibility. While plastics such as polyethylene have many beneficial uses, production and manufacture of plastics and plastic articles often impacts the environment in detrimental ways including trash production and increased emission of CO₂ during processing.

One of the largest challenges faced by society today is to reduce greenhouse gas emissions in order to minimize the impact on the climate and environment. International agreements such as the Paris Agreement of 2015 may set limits on CO₂ emissions and drive the transition to a low carbon economy based on renewable energy, in addition to the development of new economic and business models. In some cases, new production techniques and material solutions may be used to reduce the carbon footprint during plastic manufacture and a life cycle perspective may be applied to weight the possible trade-offs between material functionality and environmental impact.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to polymer compositions that include a first component having one or more biobased polymer compositions; a second component having one or more recycled polymer compositions; and an optional third component comprising one or more virgin petrochemical polymer compositions; wherein the wt % of each component is selected such that the blended polymer composition exhibits an Emission Factor_{Blend} of less than or equal to 1.0 kg CO₂/kg of the blended polymer composition, as determined according to the formula:

P1_{Biobased}·Emission factor_{P1}_{_{Biobased}}+P2_{Recycled}·Emission factor_{P2}_{_{Recycled}}+P3_{Petro}·Emission factor_{P3}_{_{Petro}}=Emission factor_{Blend};

wherein P1_{Biobased} is the weight percentage of the one or more biobased polymer compositions, P2_{Recycled} is the weight percent of the one or more recycled polymer compositions, P3_{Petro} is the weight percent of the one or more virgin petrochemical polymer compositions, Emission factor_{P1}_{_{Biobased}} is the calculated emission for the one or more biobased polymer compositions in kg CO₂/kg polymer, Emission factor_{P2}_{_{Recycled}} is the calculated emission for the one or more recycled polymer compositions in kg CO₂/kg polymer, Emission factor_{P3}_{_{Petro}} is the calculated emission for the one or more virgin petrochemical polymer compositions in kg CO₂/kg polymer, and Emission factor_{Blend} is the calculated emission for the blended polymer composition in kg CO₂/kg blended polymer composition.

In another aspect, embodiments disclosed herein relate to polymer compositions that may include a first component having one or more biobased polymer compositions, wherein the one or more biobased polymer compositions are present in an amount ranging from 2.4 wt % to 59.3 wt %; a second component having one or more recycled polymer compositions, wherein the one or more recycled polymer compositions are present in an amount ranging from 40.7 wt % to 97.6 wt %.

In another aspect, embodiments disclosed herein relate to methods that include preparing a blended polymer composition, wherein the blended polymer composition comprises: a first component having one or more biobased polymer compositions, and a second component having one or more recycled polymer compositions; wherein the percent by weight of each component is selected such that the blended polymer composition exhibits an Emission Factor_{Blend} in a range of −1.0 to 1.0 kg CO₂/kg blended polymer composition, as determined according to the formula:

P1_{Biobased}·Emission factor_{P1}_{_{Biobased}}+P2_{Recycled}·Emission factor_{P2}_{_{Recycled}}+P3_{Petro}·Emission factor_{P3}_{_{Petro}}=Emission factor_{Blend};

wherein P1_{Biobased} is the weight percentage of the one or more biobased polymer compositions, P2_{Recycled} is the weight percent of the one or more recycled polymer compositions, P3_{Petro} is the weight percent of the one or more virgin petrochemical polymer compositions, Emission factor_{P1}_{_{Biobased}} is the calculated emission for the one or more biobased polymer compositions in kg CO₂/kg polymer, Emission factor_{P2}_{_{Recycled}} is the calculated emission for the one or more recycled polymer compositions in kg CO₂/kg polymer, Emission factor_{P3}_{_{Petro}} is the calculated emission for the one or more virgin petrochemical polymer compositions in kg CO₂/kg polymer, and Emission factor_{Blend} is the calculated emission for the blended polymer composition in kg CO₂/kg blended polymer composition.

Other aspects and advantages of the claimed subject matter will be apparent from the following description and the appended claims.

### DETAILED DESCRIPTION

Embodiments of the present disclosure are directed to the production of blended polymer compositions that exhibit a reduction in carbon emissions, specifically zero or near zero emissions, and overall potential environmental impact when compared to equivalent materials produced using exclusively fossil fuel sources. In another aspect, embodiments of the present disclosure are directed to methods of reducing carbon emission during the manufacture of blended polymer compositions, including blends containing polyethylene, polypropylene, ethylene vinyl acetate (EVA) copolymer, and mixtures thereof. In particular, embodiments of the present disclosure are directed to selecting blended polymer compositions by balancing the carbon emissions for the various components, and selecting weight percentages of the various components to balance the emissions to have a zero or near-zero emissions, while also maintaining other desired properties.

In one or more embodiments, methods of blended polymer composition manufacture may exhibit carbon emission close to zero mass equivalents of CO₂ per mass of polymer (i.e., kg CO₂/kg polymer). In some embodiments, the mass equivalents of CO₂ per mass of a polymer composition may be negative, indicating a carbon uptake (also referred as carbon sequestration) of CO₂ from the atmosphere. Blended polymer compositions in accordance with the present disclosure may include a mixture of a biobased polymer composition and a recycled polymer composition, where the amount of each component is selected based on the calculated carbon footprint as determined by an “Emission Factor” calculated as shown in Eq. 1.

P1_{Biobased}·Emission factor_{P1}_{_{Biobased}}+P2_{Recycled}·Emission factor_{P2}_{_{Recycled}}+P3_{Petro}·Emission factor_{P3}_{_{Petro}}=Emission factor_{Blend} (1)

wherein P1_{Biobased} is the weight percentage of the biobased polymer composition, P2_{recycled} is the weight percent of the recycled polymer composition, P3_{Petro} is the weight percent of the one or more virgin petrochemical polymer compositions, Emission factor_{P1}_{_{Biobased}} is the calculated emission for the biobased polymer composition in kg CO₂/kg polymer, Emission factor_{P2}_{_{Recycled}} is the calculated emission for the recycled polymer composition component in g CO₂/kg polymer, Emission factor_{P3}_{_{Petro}} is the calculated emission for the one or more virgin petrochemical polymer compositions in kg CO₂/kg polymer, and Emission factor_{Blend} is the calculated emission for the final polymer composition in g CO₂/kg polymer composition.

As disclosed herein, the Emission Factor of polymer compositions may be calculated according to the international standard ISO 14044:2006—“ENVIRONMENTAL MANAGEMENT—LIFE CYCLE ASSESSMENT—REQUIREMENTS AND GUIDELINES”. The boundary conditions consider the cradle to gate approach. Numbers are based on peer reviewed LCA ISO 14044 compliant study and the environmental and life cycle model are based on SimaPro® software. Ecoinvent is used as background database and IPCC 2013 GWP100 is used as LCIA method.

Blended Polymer Compositions

In one or more embodiments, blended polymer compositions in accordance with the present disclosure may include a mixture of a biobased polymer component and a recycled polymer component. In one or more embodiments, blended polymer compositions may include a mixture of a biobased polymer component, a recycled polymer component, and a virgin petrochemical polymer component.

Polyethylene

In one or more embodiments, blended polymer compositions may include biobased and/or recycled polyethylene produced from ethylene monomers, including polyethylene of varying molecular weight and density, such as linear low density polyethylene, low density polyethylene, high density polyethylene, and blends and mixtures thereof.

Biobased Polyethylene

Biobased polyethylenes in accordance with the present disclosure may include polyolefins containing a weight percentage of biologically derived monomers. Biobased polyethylenes and monomers are derived from natural products and are distinguished from polymers and monomers obtained from fossil-fuel sources. Because biobased materials are obtained from sources that may actively reduce CO₂ in the atmosphere or otherwise require less CO₂ emission during production, such materials are often regarded as “green” or renewable.

Examples of biobased polyethylene may include polymers generated from ethylene derived from natural sources such as sugarcane and sugar beet, maple, date palm, sugar palm, sorghum, American agave, starches, corn, wheat, barley, sorghum, rice, potato, cassava, sweet potato, algae, fruit, citrus fruit, materials comprising cellulose, wine, materials comprising hemicelluloses, materials comprising lignin, cellulosics, lignocelluosics, wood, woody plants, straw, sugarcane bagasse, sugarcane leaves, corn stover, wood residues, paper, polysaccharides such as pectin, chitin, levan, pullulan, and the like, and any combination thereof.

Biobased materials may be processed by any suitable method to produce ethylene, such as the production of ethanol from sugarcane, and the subsequent dehydration of ethanol to ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Biologically sourced ethanol, known as bio-ethanol, used to produce ethylene may be obtained by the fermentation of sugars derived from cultures such as that of sugar cane and beets, or from hydrolyzed starch, which is, in turn, associated with other materials such as corn. It is also envisioned that the biobased ethylene may be obtained from hydrolysis based products from cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

Biobased polyethylenes in accordance with the present disclosure may include a polyethylene having a biobased carbon content as determined by ASTM D6866-18 Method B at a percent in a range having a lower limit selected from any of 0.05%, 0.1%, 1%, and 5%, to an upper limit selected from any of 50%, 90%, and 100%, where any lower limit may be combined with any upper limit.

In one or more embodiments, biobased products obtained from natural materials may be certified as to their renewable carbon content, according to the methodology described in the technical standard ASTM D 6866-18, “Standard Test Methods for Determining the Biobased Content of Solid, Liquid, and Gaseous Samples Using Radiocarbon Analysis.”

In one or more embodiments, blended polymer compositions may contain a percent by weight of the total composition (wt %) of biobased polyethylene ranging from a lower limit selected from one of 1 wt %, 2.4 wt. %, 4.7 wt %, 5 wt %, 5.1 wt %, 7.5 wt %, 10 wt % and 26.3 wt. %, to an upper limit selected from one of 30 wt %, 30.3 wt. %, 36.6 wt %, 51.3 wt %, 54.3 wt %, 55 wt %, 55.5 wt %, 60 wt %, and 90 wt %, where any lower limit can be used with any upper limit. Further, it is envisioned that a polymer composition may contain more or less biobased polyethylene depending on the application and the desired carbon emission profile.

In one or more embodiments, biobased polyethylene may have a melt flow index (MFI) according to ASTM D1238 at 190° C./2.16 kg having a lower limit selected from any one of 0.05 g/10 min, 0.1 g/10 min, and 0.5 g/10 min, to a upper limit selected from any one of 40 g/10 min, 50 g/10 min, and 60 g/10 min, where any lower limit may be combined with any upper limit.

In one or more embodiments, biobased polyethylene may have a density according to ASTM D1505/D792 in a range having a lower limit selected from any one of 0.800 g/cm³, 0.905 g/cm³, 0.910 g/cm³, 0.945 g/cm³, and 0.950 g/cm³ to an upper limit selected from any one of 0.945 g/cm³, 0.955 g/cm³, 0.963 g/cm³, and 0.970 g/cm³, where any lower limit may be combined with any upper limit.

In one or more embodiments, biobased polyethylene may include a linear low density polyethylene present at a percent by weight (wt %) of the polymer composition ranging from 2.6 wt % to 55.5 wt %, having a MFI (ASTM D1238 at 190° C./2.16) ranging from 0.1 g/10 min to 40 g/10 min, and a density ranging from 0.905 g/cm³ to 0.955 g/cm³.

In one or more embodiments, biobased polyethylene may include a low density polyethylene present at a percent by weight (wt %) of the polymer composition ranging from 2.5 wt % to 54.3 wt %, having a MFI (ASTM D1238 at 190° C./2.16) ranging from 0.1 g/10 min to 40 g/10 min, and a density ranging from 0.905 g/cm³ to 0.945 g/cm³.

In one or more embodiments, biobased polyethylene may include a high density polyethylene present at a percent by weight (wt %) of the polymer composition ranging from 2.4 wt % to 51.3 wt %, having an MFI (ASTM D1238 at 190° C./2.16) ranging from 0.1 g/10 min to 50 g/10 min, and a density ranging from 0.945 g/cm³ to 0.963 g/cm³.

Recycled Polyethylene

Polymer composition in accordance with the present disclosure may include recycled polyethylenes obtained from various sources including post-industrial resins, post-consumer resins, regrind polymer resins, and combinations thereof. In one or more embodiments, recycled polyethylene may be obtained by a general process of selecting a polyethylene from a polyethylene waste residue, cleaning the polyethylene, and processing the polyethylene to generate polyethylene flakes. In some embodiments, processing to generate polyethylene flakes may occur before the cleaning step. In some embodiments, the recycling process further comprises the step of extruding the polyethylene flakes to generate polyethylene pellets.

In one or more embodiments, polymer compositions may contain a percent by weight of the total composition (wt %) of recycled polyethylene ranging from a lower limit selected from one of 1 wt %, 5 wt %, 10 wt % 40 wt %, 40.7 wt. %, 44.5 wt %, 50 wt %, and 55 wt % to an upper limit selected from one of 60 wt %, 75 wt %, 80 wt %, 90 wt %, 95 wt %, 95.3 wt. %, 99.5 wt % and 99.9 wt %, where any lower limit can be used with any upper limit. Further, it is envisioned that a polymer composition may contain more or less recycled polyethylene depending on the application and the desired carbon emission profile.

Polypropylene

In one or more embodiments, polymer compositions may include biobased and recycled polypropylene produced from propylene monomers, including polypropylene of varying molecular weight and density, and blends and mixtures thereof.

Biobased Polypropylene

Biobased polypropylenes in accordance with the present disclosure may include polyolefins containing a weight percentage of biologically derived monomers. Propylene monomers may be derived from similar biological processes as discussed above with respect to biobased polyethylene, and discussed, for example, in U.S. Pat. Pub. 2013/0095542. In one or more embodiments, biologically derived n-propanol may be dehydrated to yield propylene, which is then polymerized to produce various types of polypropylene. Biobased polypropylene in accordance with the present disclosure may include a homopolymer, random copolymer, heterophasic copolymer or terpolymer, and the like.

Biobased polypropylenes in accordance with the present disclosure may include a polypropylene having a biobased carbon content as determined by ASTM D6866-18 Method B at a percent in a range having a lower limit selected from any of 0.05%, 0.1%, 1%, and 5%, to an upper limit selected from any of 50%, 90%, and 100%, where any lower limit may be combined with any upper limit.

In one or more embodiments, biobased products obtained from natural materials may be certified as to their renewable carbon content, according to the methodology described in the technical standard ASTM D 6866-06, “Standard Test Methods for Determining the Biobased Content of Natural Range Materials Using Radiocarbon and Isotope Ratio Mass Spectrometry Analysis.”

In one or more embodiments, blended polymer compositions may contain a percent by weight of the total composition (wt %) of biobased polypropylene ranging from a lower limit selected from one of 1 wt %, 2.7 wt. %, 4.7 wt %, 5 wt %, 5.1 wt %, 7.5 wt %, and 10 wt %, to an upper limit selected from one of 30 wt %, 36.6 wt %, 51.3 wt %, 54.3 wt %, 55 wt %, 55.5 wt %, 58 wt. %, 60 wt %, and 90 wt %, where any lower limit can be used with any upper limit. Further, it is envisioned that a polymer composition may contain more or less biobased polypropylene depending on the application and the desired carbon emission profile.

In one or more embodiments, biobased polypropylene may have a melt flow index (MFI) according to ASTM D1238 at 230° C./2.16 kg having a lower limit selected from any one of 0.1 g/10 min, 0.5 g/10 min, 0.7 g/10 min, and 1 g/10 min to a upper limit selected from any one of 100 g/10 min, 120 g/10 min, 125 g/10 min, and 130 g/10 min, where any lower limit may be combined with any upper limit.

In one or more embodiments, biobased polypropylene may have a density according to ASTM D1505/D792 in a range having a lower limit selected from any one of 0.800 g/cm³, 0.905 g/cm³, 0.910 g/cm³, 0.945 g/cm³, and 0.950 g/cm³ to an upper limit selected from any one of 0.945 g/cm³, 0.955 g/cm³, 0.963 g/cm³, and 0.970 g/cm³, where any lower limit may be combined with any upper limit.

Recycled Polypropylene

Blended polymer composition in accordance with the present disclosure may include recycled polypropylenes obtained from various sources including post-industrial resins, post-consumer resins, regrind polymer resins, and combinations thereof. In one or more embodiments, recycled polypropylene may be obtained by a general process of selecting a polypropylene from a polypropylene waste residue, cleaning the polypropylene, and processing the polypropylene to generate polypropylene flakes. In some embodiments, processing to generate polyethylene flakes may occur before the cleaning step. In some embodiments, the recycling process further comprises the step of extruding the polypropylene flakes to generate polypropylene pellets.

In one or more embodiments, blended polymer compositions may contain a percent by weight of the total composition (wt %) of recycled polypropylene ranging from a lower limit selected from one of 1 wt %, 5 wt %, 10 wt % 40 wt %, 41.8 wt. %, 44.5 wt %, 50 wt %, and 55 wt %, to an upper limit selected from one of 60 wt %, 75 wt %, 80 wt %, 90 wt %, 95 wt %, 97.6 wt. %, 99.5 wt % and 99.9 wt %, where any lower limit can be used with any upper limit. Further, it is envisioned that a polymer composition may contain more or less recycled polypropylene depending on the application and the desired carbon emission profile.

Biobased Ethylene Vinyl Acetate Copolymer

Polymer compositions of the present invention may incorporate one or more ethylene-vinyl acetate (EVA) copolymers prepared by the copolymerization of ethylene and vinyl acetate. In some embodiments, the EVA copolymer may be a biobased EVA, where at least one of ethylene and/or vinyl acetate monomers are derived from renewable sources, such as ethylene derived from biobased ethanol.

In one or more embodiments, the EVA copolymer exhibits a biobased carbon content, as determined by ASTM D6866 of at least 5%. Further, other embodiments may include at least 10%, 20%, 40%, 50%, 60%, 80%, or 100% bio-based carbon.

EVA copolymers in accordance with the present disclosure may have a melt flow index (MFI) at 190° C. and 2.16 kg as determined according to ASTM D1238 in a range having a lower limit selected from any one of 0.1, 1, 2, 5, 10, 20, and 50, to an upper limit selected from any one of 50, 100, 200, 300, or 400 g/10 min, where any lower limit may be combined with any upper limit.

EVA copolymers in accordance with the present disclosure may have a density determined according to ASTM D792 in a range having a lower limit selected from any one of 0.80, 0.91, 0.95, 0.97, or 1.1 g/cm³, to an upper limit selected from any one of 1.1, 1.5, 1.9, 1.21 and 1.25 g/cm³, where any lower limit may be combined with any upper limit.

Blended polymer compositions in accordance with the present disclosure may include an EVA copolymer at a percent by weight of the composition that ranges from a lower limit selected from any one of 1 wt %, 2.8 wt. %, 4.7 wt %, 5 wt %, 5.1 wt %, 7.5 wt %, and 10 wt %, to an upper limit selected from any one of 30 wt %, 36.6 wt %, 51.3 wt %, 54.3 wt %, 55 wt %, 55.5 wt %, 59.3 wt. %, 60 wt %, and 90 wt %, where any lower limit may be paired with any upper limit.

EVA copolymers in accordance with the present disclosure may have a percent by weight of ethylene in the EVA polymer that ranges from a lower limit selected from any one of 5 wt %, 25 wt %, 40 wt %, 60 wt %, 66 wt %, and 72 wt %, to an upper limit selected from any one of 80 wt %, 85 wt %, 88 wt %, 92 wt %, and 95 wt %, where any lower limit may be paired with any upper limit.

Virgin Petrochemical Resins

In one or more embodiments, the polymer compositions of the present disclosure may optionally include one or more virgin petrochemical resins (i.e., formed from fossil fuel sources), including but not limited to polyethylene, polypropylene, and ethylene vinyl acetate.

Blended polymer compositions in accordance with the present disclosure may include a virgin petrochemical resin at a percent by weight of the composition that ranges from a lower limit selected from any one of 1 wt %, 2 wt. %, 5 wt %, 7.5 wt %, and 10 wt %, to an upper limit selected from any one of 30 wt %, 40 wt %, 50 wt %, 60 wt %, and 90 wt %, where any lower limit may be paired with any upper limit.

In one or more embodiments, blended polymer compositions in accordance with the present disclosure may have an Emission Factor as calculated according to Eq. 1 that is less than 1.0 kg CO₂/kg polymer composition. In some embodiments, polymer compositions may have an Emission Factor as calculated according to Eq. 1 in the range of −1.0 to 1.0 kg CO₂/kg blended polymer composition. In some embodiments, polymer compositions may have an Emission Factor as calculated according to Eq. 1 of 0 kg CO₂/kg blended polymer composition. While a range of Emission Factors are presented, it is envisioned that the Emission Factor may be approximately 0 or less negative than −1 in some embodiments, depending on the available starting materials and application requirements of the final polymer composition. In one or more embodiments, the polymer compositions of the present disclosure may have an Emission Factor, measured according to Eq. 1, having a lower limit of any of −1, −0.5, −0.25, −0.1, or 0.05, and an upper limit of any of 1, 0.5, 0.25, 0.1, or 0.05, where any lower limit can be used in combination with any upper limit.

Additives

In one or more embodiments, the polymer compositions of the present disclosure may contain a number of other functional additives that modify various properties of the composition such as antioxidants, pigments, fillers, reinforcements, adhesion-promoting agents, biocides, whitening agents, nucleating agents, anti-statics, anti-blocking agents, processing aids, flame-retardants, plasticizers, light stabilizers, and the like.

In one or more embodiments, polymer compositions may contain a percent by weight of the total composition (wt %) of one or more additives ranging from a lower limit selected from one of 0.001 wt %, 0.01 wt %, 0.05 wt %, 0.5 wt %, and 1 wt %, to an upper limit selected from one of 1.5 wt %, 2 wt %, 5 wt %, 7 wt %, and 15 wt % where any lower limit can be used with any upper limit. While a number of potential ranges for polymer additives have been introduced, the additives are not considered in the determination of the Emission Factor for the respective polymer composition.

Masterbatch Formulations

In one or more embodiments, polymer compositions may be formulated as a masterbatch (concentration polymer mixture) that is diluted with a secondary polymer to produce a stock polymer for use to make polymer pellets, flakes, and other feedstocks, or used to make polymer articles. Specifically, masterbatch formulations in accordance with the present disclosure may be combined with a secondary polymer composition in order to minimize the carbon footprint of the secondary polymer composition to an acceptable level to comply with governmental or industry standards. In some embodiments, secondary polymer compositions may include polyethylenes of various molecular weight and densities.

In one or more embodiments, a polymer composition may contain a percent by weight of the total composition (wt %) of a concentrated master stock of a polymer composition containing biobased polymer and/or recycled polymer ranging from a lower limit selected from one of 10 wt %, 20 wt % 25 wt %, 30 wt %, 40 wt %, and 50 wt % to an upper limit selected from one of 50 wt %, 60 wt %, and 70 wt %, where any lower limit can be used with any upper limit.

Polymer Composition Preparation Methods

Polymer compositions in accordance with the present disclosure may be prepared by a number of possible polymer blending and formulation techniques, which will be discussed in the following sections.

In one or more embodiments, the polymer composition is combined with a secondary polymer composition in a melt blend process. In one or more other embodiments, the polymer composition is combined with a secondary polymer composition in a dry blend process. Thus, the polymer may be formulated as a masterbatch formulation that may be diluted in a subsequent melt-blend or dry blend process to form the final polymer composition having the improved properties.

Solubilization

Polymer compositions in accordance with the present disclosure may be prepared from the constituent components using a number of techniques. In one or more embodiments, a biobased polymer and a recycled polymer may be solubilized in a suitable organic solvent such as decalin, 1,2-dichlorobenzene, 1,1,1,3,3,3-hexafluor isopropanol, and the like. The solvent mixture may then be heated to a temperature, such as between 23° C. and 130° C., under stirring to blend the polymers

Extrusion

In one or more embodiments, polymer compositions in accordance with the present disclosure may be prepared using continuous or discontinuous extrusion. Methods may use single-, twin- or multi-screw extruders, which may be used at temperatures ranging from 100° C. to 270° C. in some embodiments, and from 140° C. to 230° C. in some embodiments. In some embodiments, raw materials are added to an extruder, simultaneously or sequentially, into the main or secondary feeder in the form of powder, granules, flakes or dispersion in liquids as solutions, emulsions and suspensions of one or more components.

Methods of preparing polymer compositions in accordance with the present disclosure may include the general steps of combining one or more biobased polymers and one or more recycled polymers in an extruder; melt extruding the one or more biobased polymers and the one or more recycled polymers as a blended polymer composition; and forming pellets, films, sheets or molded articles from the blended polymer composition. In one or more embodiments, methods of preparing polymer compositions may involve a single extrusion or multiple extrusions following the sequences of the blend preparation stages.

In one or more embodiments, polymer composition components can be pre-dispersed prior to extrusion using intensive mixers, for example. Inside an extrusion equipment, the components are heated by heat exchange and/or mechanical friction, the phases are melt and the dispersion occurs by the deformation of the polymer. In some embodiments, one or more compatibilizing agents (such as a functionalized polyolefin) between polymers of different natures may be used to facilitate and/or refine the distribution of the polymer phases and to enable the formation of the morphology of conventional blend and/or of semi-interpenetrating network at the interface between the phases.

In one or more embodiments, extrusion techniques in accordance with the present disclosure may also involve the preparation of a polymer composition concentrate (a masterbatch) that is then combined with other components to produce a polymer composition of the present disclosure.

Polymer compositions prepared by extrusion may be in the form of granules that are applicable to different molding processes, including processes selected from extrusion molding, coextrusion molding, extrusion coating, injection molding, injection blow molding, inject stretch blow molding, thermoforming, cast film extrusion, blown film extrusion, foaming, extrusion blow-molding, injection stretched blow-molding, rotomolding, pultrusion, calendering, additive manufacturing, lamination, and the like, to produce manufactured articles.

In one or more embodiments, the article is an injection molded article, a thermoformed article, a film, a foam, a blow molded article, an additive manufactured article, a compressed article, a coextruded article, a laminated article, an injection blow molded article, a rotomolded article, an extruded article, monolayer articles, multilayer articles, or a pultruded article, and the like. In embodiments of a multilayer article, it is envisioned that at least one of the layers comprises the polymer composition of the present disclosure.

Applications

In one or more embodiments, polymer compositions may be used in the manufacturing of articles, including rigid and flexible packaging for food products, chemicals, household chemicals, agrochemicals, fuel tanks, water and gas pipes, pipe coatings, geomembranes, and the like. Further examples of articles that may be produced using polymer compositions in accordance with the present disclosure include caps, closures, films, injected parts, hygienic absorbents, small volume blown articles, large volume blown articles, foams, expanded articles, thermoformed articles, household appliances, injected articles, domestic utilities, technical parts, air ducts, automotive parts and reservoirs, cylinders, perforated coils, geodesic blankets, bags, bags in general, housewares, diaper back cover, bedliner, cisterns, water boxes, boxes, bins, garbage collector, shoulders of pipes, tubes, ropes, oriented structures, biaxially-oriented films such as biaxial-oriented polypropylene (BOPP), plastic furniture, battery boxes, crates, plates, sheets, tubes, pipes, containers, electronic articles, textile articles, ribbons, raffia, tapes, filaments, drawers, ropes, fishing nets, technical coils, carpets, broomsticks, screens, archive tapes, bottles, profiles, thermal insulation, cups, pots, IBC (intermediate bulk container), packaging for cosmetics, packaging for hygiene and cleaning products, food packaging, multilayer packaging rigid, flexible multilayer packing, bungs, masterbatches, extrusion coating, packaging for pharmaceutical products, coextruded packaging, jars, tarpaulins, sacks, liner, laminate, tubes, kayaks, water tank, septic tanks, and other types of tanks.

### EXAMPLES

### Example 1: Calculation of Emission Factor for Biobased Polyethylene

The following example presents a life cycle analysis of the steps involved in the production of a biobased polyethylene from sugarcane, with Emission Factors calculated for each step. The individual and total Emission Factor contributions are shown in Table 1.

TABLE 1
Sample calculation of an Emission Factor for the
production of a biobased polyethylene

| | | Emission Factor |
|---|---|---|
| Impact Category | Resin | (kg CO₂eq/kg resin) |
| Sugarcane production | Agricultural operations | 0.91 |
| | Land use change credits | −1.10 |
| | CO₂ Uptake | −3.14 |
| | Subtotal | −3.33 |
| Ethanol Production | Ethanol production | 0.03 |
| | Bagasse burning | 0.16 |
| | Electricity cogeneration | −1.17 |
| | credits | |
| | Subtotal | −0.98 |
| Biobased PE Production | Ethanol transport | 0.46 |
| | Industrial Operations | 0.76 |
| | (Ethylene and PE) | |
| | Subtotal | 1.22 |
| | TOTAL | −3.09 |

### Example 2: Calculation of Emission Factor for Recycled Polyethylene

In the next example, the Emission Factor for producing a recycled polyethylene is shown in Table 2. The Emission Factor is calculated in mass equivalents of CO₂ per mass unit of material obtained during the recycling process. In the case of recycled polyethylene, the contribution for each step and/or component used in the production process for a recycled polyethylene as determined from sum of the CO₂ emissions during processing.

TABLE 2
Associated Emission Factors for various recycled polyethylenes.

| | Emission Factor |
|---|---|
| Recycled PE Source | (kg CO₂eq/kg resin) |
| Post-consumer PE | 1.05 |
| Post-consumer Sorting | 0.00286 |
| Collection and transport | 0.0218 |
| PE Flake Production | 0.0224 |
| Wastewater treatment | 0.00652 |
| Pellets Production | 0.0772 |
| Final transport to Sao Paulo - PCR | 0.0191 |
| Total | 1.20 |

### Example 3: Polymer Composition Formulation

In the next example polymer compositions in accordance with the present disclosure were prepared from a number of polyethylene sources shown below in Table 3.

TABLE 3
Polyethylene sources used in sample formulations.

| | Emission factor |
|---|---|
| Resin | (kg CO₂eq/kg resin) |
| Biobased HDPE | −3.09 |
| Biobased LDPE | −2.85 |
| Biobased LLDPE | −2.77 |
| Recycled Polyethylene | 1.20 |

The polymer compositions were prepared such that the Emission Factor falls in a predetermined range of carbon emission that varies from −1 to 1 kg CO₂/kg blend as determined according to Eq. (1). The developed compositions and their associated Emission factors are shown in Table 4.

TABLE 4
Sample formulations for Example 3.

| | | | | Recycled PE |
|---|---|---|---|---|
| | Biobased | Emission Factor | Biobased PE | Grade |
| Formula | Resin type | (±kg CO₂/kg blend) | (wt %) | (wt %) |
| A | HDPE | 0.00 | 28.0 | 72.0 |
| | LDPE | 0.00 | 29.6 | 70.4 |
| | LLDPE | 0.00 | 30.3 | 69.7 |
| B | HDPE | −0.05 | 29.2 | 70.8 |
| | LDPE | −0.05 | 30.9 | 69.1 |
| | LLDPE | −0.05 | 31.6 | 68.4 |
| | HDPE | 0.05 | 26.8 | 73.2 |
| | LDPE | 0.05 | 28.4 | 71.6 |
| | LLDPE | 0.05 | 29.0 | 71.0 |
| C | HDPE | −0.10 | 30.3 | 69.7 |
| | LDPE | −0.10 | 32.1 | 67.9 |
| | LLDPE | −0.10 | 32.8 | 67.2 |
| | HDPE | 0.10 | 25.7 | 74.3 |
| | LDPE | 0.10 | 27.2 | 72.8 |
| | LLDPE | 0.10 | 27.8 | 72.2 |
| D | HDPE | −0.25 | 33.8 | 66.2 |
| | LDPE | −0.25 | 35.8 | 64.2 |
| | LLDPE | −0.25 | 36.6 | 63.4 |
| | HDPE | 0.25 | 22.2 | 77.8 |
| | LDPE | 0.25 | 23.5 | 76.5 |
| | LLDPE | 0.25 | 24.0 | 76.0 |
| E | HDPE | −0.50 | 39.7 | 60.3 |
| | LDPE | −0.50 | 42.0 | 58.0 |
| | LLDPE | −0.50 | 42.9 | 57.1 |
| | HDPE | 0.50 | 16.4 | 83.6 |
| | LDPE | 0.50 | 17.3 | 82.7 |
| | LLDPE | 0.50 | 17.7 | 82.3 |
| F | HDPE | −1.00 | 51.3 | 48.7 |
| | LDPE | −1.00 | 54.3 | 45.7 |
| | LLDPE | −1.00 | 55.5 | 44.5 |
| | HDPE | 1.00 | 4.7 | 95.3 |
| | LDPE | 1.00 | 5.0 | 95.0 |
| | LLDPE | 1.00 | 5.1 | 94.9 |

### Example 4: Biobased Polyethylene and Recycled Polypropylene

In the next example, blended polymer compositions were prepared from a blend of biobased polyethylene and recycled polypropylene. The developed compositions and their associated Emission factors are shown in Table 5.

TABLE 5
Sample formulations for Example 4

| | Biobased | Carbon Emission | Biobased PE | Recycled PP |
|---|---|---|---|---|
| Formula | Resin type | (±kg CO₂/kg blend) | (wt %) | (wt %) |
| A | HDPE | 0.00 | 26.3 | 73.7 |
| | LDPE | 0.00 | 27.8 | 72.2 |
| | LLDPE | 0.00 | 28.4 | 71.6 |
| B | HDPE | −0.05 | 27.4 | 72.6 |
| | LDPE | −0.05 | 29.1 | 70.9 |
| | LLDPE | −0.05 | 29.7 | 70.3 |
| | HDPE | 0.05 | 25.1 | 74.9 |
| | LDPE | 0.05 | 26.6 | 73.4 |
| | LLDPE | 0.05 | 27.2 | 72.8 |
| C | HDPE | −0.10 | 28.6 | 71.4 |
| | LDPE | −0.10 | 30.3 | 69.7 |
| | LLDPE | −0.10 | 31.0 | 69.0 |
| | HDPE | 0.10 | 23.9 | 76.1 |
| | LDPE | 0.10 | 25.3 | 74.7 |
| | LLDPE | 0.10 | 25.9 | 74.1 |
| D | HDPE | −0.25 | 32.2 | 67.8 |
| | LDPE | −0.25 | 34.1 | 65.9 |
| | LLDPE | −0.25 | 34.9 | 65.1 |
| | HDPE | 0.25 | 20.3 | 79.7 |
| | LDPE | 0.25 | 21.5 | 78.5 |
| | LLDPE | 0.25 | 22.0 | 78.0 |
| E | HDPE | −0.50 | 38.2 | 61.8 |
| | LDPE | −0.50 | 40.5 | 59.5 |
| | LLDPE | −0.50 | 41.4 | 58.6 |
| | HDPE | 0.50 | 14.3 | 85.7 |
| | LDPE | 0.50 | 15.2 | 84.8 |
| | LLDPE | 0.50 | 15.5 | 84.5 |
| F | HDPE | −1.00 | 50.1 | 49.9 |
| | LDPE | −1.00 | 53.1 | 46.9 |
| | LLDPE | −1.00 | 54.3 | 45.7 |
| | HDPE | 1.00 | 2.4 | 97.6 |
| | LDPE | 1.00 | 2.5 | 97.5 |
| | LLDPE | 1.00 | 2.6 | 97.4 |

### Example 5: Biobased Polypropylene and Recycled Polyethylene

In the next example, blended polymer compositions were prepared from a blend of biobased polyethylene and recycled polypropylene. The developed compositions and their associated Emission factors are shown in Table 6.

TABLE 6
Sample formulations for Example 5

| | Biobased | Carbon Emission | Biobased PP | Recycled PE |
|---|---|---|---|---|
| Option | Resin type | (±kg CO₂/kg blend) | (wt %) | (wt %) |
| A | Biobased PP | 0.00 | 31.6 | 68.4 |
| B | Biobased PP | −0.05 | 33.0 | 67.0 |
| | Biobased PP | 0.05 | 30.3 | 69.7 |
| C | Biobased PP | −0.10 | 34.3 | 65.7 |
| | Biobased PP | 0.10 | 29.0 | 71.0 |
| D | Biobased PP | −0.25 | 38.2 | 61.8 |
| | Biobased PP | 0.25 | 25.1 | 74.9 |
| E | Biobased PP | −0.50 | 44.8 | 55.2 |
| | Biobased PP | 0.50 | 18.5 | 81.5 |
| F | Biobased PP | −1.00 | 58.0 | 42.0 |
| | Biobased PP | 1.00 | 5.3 | 94.7 |

### Example 6: Biobased Polypropylene and Recycled Polypropylene

In the next example, blended polymer compositions were prepared from a blend of biobased polypropylene and recycled polypropylene. The developed compositions and their associated Emission factors are shown in Table 7.

TABLE 7
Sample formulations for Example 6

| | Biobased | Carbon Emission | Biobased PP | Recycled PP |
|---|---|---|---|---|
| Option | Resin type | (±kg CO₂/kg blend) | (wt %) | (wt %) |
| A | Biobased PP | 0.00 | 29.7 | 70.3 |
| B | Biobased PP | −0.05 | 31.1 | 68.9 |
| | Biobased PP | 0.05 | 28.4 | 71.6 |
| C | Biobased PP | −0.10 | 32.4 | 67.6 |
| | Biobased PP | 0.10 | 27.0 | 73.0 |
| D | Biobased PP | −0.25 | 36.5 | 63.5 |
| | Biobased PP | 0.25 | 23.0 | 77.0 |
| E | Biobased PP | −0.50 | 43.3 | 56.7 |
| | Biobased PP | 0.50 | 16.2 | 83.8 |
| F | Biobased PP | −1.00 | 56.8 | 43.2 |
| | Biobased PP | 1.00 | 2.7 | 97.3 |

### Example 7: Calculation of Emission Factor for Biobased EVA (Ethylene Vinyl Acetate)

The following example presents a life cycle analysis of the steps involved in the production of a biobased EVA from sugarcane, with Emission Factors calculated for each step. The individual and total Emission Factor contributions are shown in Table 8.

TABLE 8
Sample calculation of an Emission Factor
for the production of a biobased EVA

| | Emission Factor |
|---|---|
| Resin | (kg CO₂eq/kg resin) |
| Land Use Change | −0.8452 |
| Sugarcane Production | 0.5578 |
| Harvesting controlled burning | 0.0140 |
| Sugarcane Harvest and Transportation | 0.0754 |
| Ethanol production | 0.0264 |
| Electricity cogeneration credits | −0.8962 |
| Bagasse burning | 0.1057 |
| Ethanol transport | 0.3550 |
| Biobased Ethylene Production and Transportation | 0.3757 |
| Vinyl Acetate Production and Transportation | 0.3478 |
| Biobased EVA polymerization | 0.2956 |
| CO₂ Uptake | −2.9210 |
| Total | −2.5091 |

### Example 8: Biobased EVA and Recycled Polyethylene

In the next example, blended polymer compositions were prepared from a blend of biobased EVA and recycled polyethylene. The developed compositions and their associated Emission factors are shown in Table 9.

TABLE 9
Sample formulations for Example 8

| | | Carbon Emission | | Recycled |
|---|---|---|---|---|
| | Biobased | (±kg CO2/kg | Biobased EVA | PE |
| Option | Resin type | blend) | Grade (wt %) | (wt %) |
| A | Biobased EVA | 0.00 | 32.4 | 67.6 |
| B | Biobased EVA | −0.05 | 33.7 | 66.3 |
| | Biobased EVA | 0.05 | 31.0 | 69.0 |
| C | Biobased EVA | −0.10 | 35.1 | 64.9 |
| | Biobased EVA | 0.10 | 29.7 | 70.3 |
| D | Biobased EVA | −0.25 | 39.1 | 60.9 |
| | Biobased EVA | 0.25 | 25.7 | 74.3 |
| E | Biobased EVA | −0.50 | 45.9 | 54.1 |
| | Biobased EVA | 0.50 | 18.9 | 81.1 |
| F | Biobased EVA | −1.00 | 59.3 | 40.7 |
| | Biobased EVA | 1.00 | 5.4 | 94.6 |

### Example 9: Biobased EVA and Recycled Polypropylene

In the next example, blended polymer compositions were prepared from a blend of biobased EVA copolymer and recycled polypropylene. The developed compositions and their associated Emission factors are shown in Table 10.

TABLE 10
Sample formulations for Example 9

| | Biobased | Carbon Emission | Biobased | Recycled PP |
|---|---|---|---|---|
| Option | Resin type | (±kg CO2/kg blend) | EVA (%) | (%) |
| A | Biobased EVA | 0.00 | 30.5 | 69.5 |
| B | Biobased EVA | −0.05 | 31.9 | 68.1 |
| | Biobased EVA | 0.05 | 29.1 | 70.9 |
| C | Biobased EVA | −0.10 | 33.2 | 66.8 |
| | Biobased EVA | 0.10 | 27.7 | 72.3 |
| D | Biobased EVA | −0.25 | 37.4 | 62.6 |
| | Biobased EVA | 0.25 | 23.5 | 76.5 |
| E | Biobased EVA | −0.50 | 44.3 | 55.7 |
| | Biobased EVA | 0.50 | 16.6 | 83.4 |
| F | Biobased EVA | −1.00 | 58.2 | 41.8 |
| | Biobased EVA | 1.00 | 2.8 | 97.2 |

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A blended polymer composition comprising:
a first component comprising one or more biobased polymer compositions;
a second component comprising one or more recycled polymer compositions; and
an optional third component comprising one or more virgin petrochemical polymer compositions, wherein the wt % of each component is selected such that the blended polymer composition exhibits an Emission Factor_{Blend} of less than or equal to 1.0 kg CO₂/kg of the blended polymer composition, as determined according to the formula:
P1_{Biobased}·Emission factor_{P1}_{_{Biobased}}+P2_{Recycled}·Emission factor_{P2}_{_{Recycled}}+P3_{Petro}·Emission factor_{P3}_{ₚₑₜᵣₒ}=Emission factor_{Blend};
wherein P1_{Biobased} is the weight percentage of the one or more biobased polymer compositions, P2_{Recycled} is the weight percent of the one or more recycled polymer compositions, P3_{Petro} is the weight percent of the one or more virgin petrochemical polymer compositions, Emission factor_{P1}_{_{Biobased}} is the calculated emission for the one or more biobased polymer compositions in kg CO₂/kg polymer, Emission factor_{P2}_{_{Recycled}} is the calculated emission for the one or more recycled polymer compositions in kg CO₂/kg polymer, Emission factorₚ₃_{ₚₑₜᵣₒ} is the calculated emission for the one or more virgin petrochemical polymer compositions in kg CO₂/kg polymer, and Emission factor_{Blend} is the calculated emission for the blended polymer composition in kg CO₂/kg blended polymer composition.

2. The blended polymer composition of claim 1, wherein the one or more biobased polymer compositions are present in an amount ranging from 2.4 wt % to 59.3 wt %.

3. The blended polymer composition of claim 1, wherein the one or more recycled polymer compositions are present in an amount ranging from 40.7 wt % to 97.6 wt %.

4. The blended polymer composition of claim 1, wherein the one or more biobased polymer compositions have a melt flow index (MFI) according to ASTM D1238 at 190° C./2.16 kg in a range of 0.05 g/10 min to 400 g/10 min.

5. The blended polymer composition of claim 1, wherein the one or more biobased polymer compositions have a melt flow index (MFI) according to ASTM D1238 at 230° C./2.16 kg in a range of 0.1 g/10 min to 130 g/10 min.

6. The blended polymer composition of claim 1, wherein the one or more biobased polymer compositions have a density according to ASTM D1505/D792 in a range of 0.800 g/cm³ to 0.970 g/cm³.

7. The blended polymer composition of claim 1, wherein the one or more recycled polymer compositions comprise a post-industrial polymer resin, a post-consumer polymer resin, a regrind polymer resin, or combinations thereof.

8. The blended polymer composition of claim 1, wherein the blended polymer composition has an Emission Factor_{Blend} in the range of −1 to 1 g CO₂/kg blended polymer composition.

9. The blended polymer composition of claim 1, wherein the blended polymer composition is prepared by a melt blending process.

10. The blended polymer composition of claim 9, wherein the melt blending process comprises combining the one or more biobased polymer compositions and the one or more recycled polymer compositions, wherein at least one of the one or more biobased polymer compositions and the one or more recycled polymer compositions is in the form of pellets or flakes.

11. The blended polymer composition of claim 1, wherein the one or more biobased polymer compositions comprise biobased polyethylene and the one or more recycled polymer compositions comprise recycled polyethylene.

12. The blended polymer composition of claim 1, wherein the one or more biobased polymer compositions comprise biobased polyethylene and the one or more recycled polymer compositions comprise recycled polypropylene.

13. The blended polymer composition of claim 1, wherein the one or more biobased polymer compositions are one or more selected from a group consisting of high density polyethylene, low density polyethylene, and linear low density polyethylene.

14. The blended polymer composition of claim 1, wherein the one or more biobased polymer compositions comprise biobased polypropylene and the one or more recycled polymer compositions comprise recycled polyethylene.

15. The blended polymer composition of claim 1, wherein the one or more biobased polymer compositions are linear low density polyethylene present at 2.6 wt % to 55.5 wt %, having a MFI (ASTM D1238 at 190° C./2.16 kg) ranging from 0.1 to 40 g/10 min, a density ranging from 0.905 g/cm³ to 0.955 g/cm³.

16. The blended polymer composition of claim 1, wherein the one or more biobased polymer compositions are low density polyethylene present at 2.5 wt % to 54.3 wt %, having a MFI (ASTM D1238 at 190° C./2.16 kg) ranging from 0.1 to 40 g/10 min, and a density ranging from 0.905 g/cm³ to 0.945 g/cm³.

17. The blended polymer composition of claim 1, wherein the one or more biobased polymer compositions are high density polyethylene present at 2.4 wt % to 51.3 wt %, having an MFI (ASTM D1238 at 190° C./2.16 kg) ranging from 0.1 to 50 g/10 min, and a density ranging from 0.945 g/cm³ to 0.963 g/cm³.

18. The blended polymer composition of claim 1, wherein the one or more biobased polymer compositions comprise biobased polypropylene and the one or more recycled polymer compositions comprise recycled polypropylene.

19. The blended polymer composition of claim 1, wherein the one or more biobased polymer compositions comprise biobased ethylene vinyl acetate copolymer and the one or more recycled polymer compositions comprise recycled polyethylene.

20. The blended polymer composition of claim 1, wherein the one or more biobased polymer compositions comprise biobased ethylene vinyl acetate copolymer and the one or more recycled polymer compositions comprise recycled polypropylene.

21. The blended polymer composition of claim 1, wherein the one or more biobased polymer compositions comprise biobased ethylene vinyl acetate copolymer and the one or more recycled polymer compositions comprise recycled ethylene vinyl acetate copolymer.

22. An article comprising the blended polymer composition according to claim 1.

23. The article of claim 22, wherein the article is prepared by a method selected from a group consisting of extrusion molding, coextrusion molding, extrusion coating, injection molding, injection blow molding, inject stretch blow molding, thermoforming, cast film extrusion, blown film extrusion, foaming, extrusion blow-molding, injection stretched blow-molding, rotomolding, pultrusion, calendering, additive manufacturing, and lamination.

24. The article of claim 22, wherein the article is selected from a group consisting of caps, closures, films, injected parts, hygienic absorbents, small volume blown articles, large volume blown articles, foams, expanded articles, thermoformed articles, household appliances, injected articles, domestic utilities, technical parts, air ducts, automotive parts and reservoirs, cylinders, perforated coils, geodesic blankets, bags, bags in general, housewares, diaper back cover, bedliner, cisterns, water boxes, boxes, bins, garbage collector, shoulders of pipes, tubes, ropes, oriented structures, biaxially-oriented films such as biaxial-oriented polypropylene (BOPP), plastic furniture, battery boxes, crates, plates, sheets, tubes, pipes, containers, electronic articles, textile articles, ribbons, raffia, tapes, filaments, drawers, ropes, fishing nets, technical coils, carpets, broomsticks, screens, archive tapes, bottles, profiles, thermal insulation, cups, pots, intermediate bulk containers, packaging for cosmetics, packaging for hygiene and cleaning products, food packaging, multilayer packaging rigid, flexible multilayer packing, bungs, masterbatches, extrusion coating, packaging for pharmaceutical products, coextruded packaging, jars, tarpaulins, sacks, liner, laminate, tubes, kayaks, water tank, and septic tanks.

25. A blended polymer composition comprising:
a first component comprising one or more biobased polymer compositions, wherein the one or more biobased polymer compositions are present in an amount ranging from 2.4 wt % to 59.3 wt %;
a second component comprising one or more recycled polymer compositions, wherein the one or more recycled polymer compositions are present in an amount ranging from 40.7 wt % to 97.6 wt %.

26. An article comprising the blended polymer composition of claim 25.

27. A method, comprising:
preparing a blended polymer composition, wherein the blended polymer composition comprises:
a first component comprising one or more biobased polymer compositions, and
a second component comprising one or more recycled polymer compositions;
wherein the percent by weight of each component is selected such that the blended polymer composition exhibits an Emission Factor_{Blend} in a range of −1.0 to 1.0 kg CO₂/kg blended polymer composition, as determined according to the formula:
P1_{Biobased}·Emission factor_{P1}_{_{Biobased}}+P2_{Recycled}·Emission factor_{P2}_{_{Recycled}}+P3_{Petro}=Emission factor_{P3}_{ₚₑₜᵣₒ}=Emission factor_{Blend};
wherein P1_{Biobased} is the weight percentage of the one or more biobased polymer compositions, P2_{Recycled} is the weight percent of the one or more recycled polymer compositions, P3ₚₑₜᵣₒ is the weight percent of the one or more virgin petrochemical polymer compositions, Emission factor_{P1}_{_{Biobased}} is the calculated emission for the one or more biobased polymer compositions in kg CO₂/kg polymer, Emission factor_{P2}_{_{Recycled}} is the calculated emission for the one or more recycled polymer compositions in kg CO₂/kg polymer, Emission factor_{P3}_{_{Petro}} is the calculated emission for the one or more virgin petrochemical polymer compositions in kg CO₂/kg polymer, and Emission factor_{Blend} is the calculated emission for the blended polymer composition in kg CO₂/kg blended polymer composition.

28. The method of claim 27, wherein the one or more recycled polymer compositions comprise a post-industrial polymer resin, a post-consumer polymer resin, a regrind polymer resin, or combinations thereof.

29. The method of claim 27, wherein the one or more biobased polymer compositions have a biobased ethylene content ranging from 0.1 to 100 wt. %.

30. The method of claim 27, wherein the one or more biobased polymer compositions comprise biobased polyethylene and the one or more recycled polymer compositions comprise recycled polyethylene.

31. The method of claim 27, wherein the one or more biobased polymer compositions comprise biobased polyethylene and the one or more recycled polymer compositions comprise recycled polypropylene.

32. The method of claim 27, wherein the one or more biobased polymer compositions are one or more selected from a group consisting of high density polyethylene, low density polyethylene, and linear low density polyethylene.

33. The method of claim 27, wherein the one or more biobased polymer compositions comprise biobased polypropylene and the one or more recycled polymer compositions comprise recycled polyethylene.

34. The method of claim 27, wherein the one or more biobased polymer compositions comprise biobased polypropylene and the one or more recycled polymer compositions comprise recycled polypropylene.

35. The method of claim 27, wherein the one or more biobased polymer compositions comprise biobased ethylene vinyl acetate copolymer and the one or more recycled polymer compositions comprise recycled polyethylene.

36. The method of claim 27, wherein the one or more biobased polymer compositions comprise biobased ethylene vinyl acetate copolymer and the one or more recycled polymer compositions comprise recycled polypropylene.

37. The method of claim 27, wherein the one or more biobased polymer compositions comprise biobased ethylene vinyl acetate copolymer and the one or more recycled polymer compositions comprise recycled ethylene vinyl acetate copolymer.

38. The method of claim 27, wherein preparing the composition comprises one or more selected form a group consisting of extrusion molding, coextrusion molding, extrusion coating, injection molding, injection blow molding, inject stretch blow molding, thermoforming, cast film extrusion, blown film extrusion, foaming, extrusion blow-molding, injection stretched blow-molding, rotomolding, pultrusion, calendering, additive manufacturing, and lamination.

39. The method of claim 27, wherein the one or more recycled polymer compositions is obtained from a recycling process comprising the steps of:
selecting a polymer composition from post-consumer residue,
processing the polymer composition to generate polymer composition flakes, and,
cleaning the polymer composition flakes.

40. The method of claim 39, wherein the recycling process further comprises the step of extruding the polymer composition flakes to generate polymer composition pellets.

41. The method of claim 27, wherein preparing the blended polymer composition comprises:
adding the one or more biobased polymer compositions and the one or more recycled polymer compositions to an extruder;
melt extruding the one or more biobased polymer compositions and the one or more recycled polymer compositions as a blended polymer composition; and
forming pellets, films, sheets, or molded articles from the blended polymer composition.
